(19) United States
(12) Patent Application Publication
(10) Pub. No.: US 2014/0318900 A1
(43) Pub. Date: Oct. 30, 2014

(54) PUMPING SYSTEM AND SHAFT FOR OIL PUMPING SYSTEM FOR HERMETIC COMPRESSORS AND COMPRESSOR COMPRISING THE SYSTEM AND/OR SHAFT

(71) Applicants: Fábio Krug Rocha, Joinville SC (BR); Milton Wetzel Pereira, Joinville SC (BR)

(72) Inventors: Fábio Krug Rocha, Joinville SC (BR); Milton Wetzel Pereira, Joinville SC (BR)

(73) Assignee: WHIRLPOOL S.A., Sao Paulo SP (BR)

(21) Appl. No.: 14/235,997

(22) PCT Filed: Jul. 20, 2012
(86) PCT No.: PCT/BR2012/000247

§ 371 Date: Jul. 14, 2014

(30) Foreign Application Priority Data
Jul. 29, 2011 (BR) PI1103384-3

(51) Int. Cl. F16N 13/22

(52) U.S. Cl. CPC F16N 13/22
USPC 184/26

(57) ABSTRACT

A pumping system, a shaft for the oil pumping system for hermetic compressors, as well as a compressor including the system and/or the shaft are described. It is foreseen the change in the dimensions and geometry of lubricating oil pumping systems in hermetic compressors which have an oil pump (9) immersed in lubricating oil (2) and associated with a revolving vertical shaft (5) which is rotated by a rotor (6) of an electric motor (7). The oil pumping system also includes the addition of a bent hole (12) in relation to the center line of a revolving vertical shaft (5), apart from a bent lubricating hole in this bent suction tube (12) in the inner portion of the shaft (14). The system further presents changes in the dimensions of the suction hole (9a) and in the position for fixing an oil pump (9), apart from the progressive reduction in the thickness of the wall (16) of the revolving vertical shaft (5).

The present invention refers to a change in the dimensions and geometry of lubricating oil pumping systems in hermetic compressors which have an oil pump immersed in lubricating oil associated with a revolving vertical shaft which is driven by a rotor of an electric motor. The oil pumping system also comprises the addition of a bent inner hole to the revolving vertical shaft, resulting in the progressive reduction in the thickness of the shaft wall. The system also has changes in the dimensions of the suction hole and in the position for fixing an oil pump.

### Description of the State of the Art

Cooling devices or even heat pumps generally use hermetic compressors, which may use electric motors with rotors comprising permanent magnetos, capable of varying the angular velocity of the compressor's shaft within a rotation range, discretely or continuously.

In this regard, these compressors need lubrication, whose purpose is to separate and facilitate the movement of two surfaces which move one towards the other, without causing damages to them. Lubrication occurs by adding a certain amount of oil between the parts in order to prevent pieces with friction from having metallic contact with any other part, either movable or fixed, when performing any movement. The oil is added by means of oil pumping, which is performed by centrifugal effect due to the rotation of a shaft which comprises an associated oil pump. The centrifugal effect results in an oil parabolic profile, whose upper end shall achieve or exceed a point of oil availability for lubrication of the pieces, preferably the bearings in the compressor.

Therefore, the thickness of the oil film (□□□) available for lubrication of the movable pieces can be obtained according to a theoretical formula which can be approximate to

$$□ □ □ = □ □ - \sqrt{{□}_{□}^{2} + \frac{2 * □ * □}{{□}_{□ □}^{2}}} ,$$

whereas

□□ is the shaft radius, □_{□} is the radius of the pump's suction hole, g is gravity and h is the pumping height, and □_{□□} is the angular speed of the revolving vertical shaft.

If the angular speed of the revolving vertical shaft (□_{□□} ) is lower than a certain limit value, the end of the rising curve of the oil profile will not reach the point of oil availability, so there will be no oil pumping for lubrication. The amount of pumped oil also depends on the pumping height (h), and this height is the distance between the level of oil in the reservoir and the point of lubricating oil availability and the radiuses of the pump's suction hole (□_{□}) and the revolving vertical shaft (□□).

For this reason, to ensure the efficient and sufficient lubrication of the bearings and movable pieces, some techniques to control compressors are currently used. One of the techniques for a more efficient lubrication of the piston cylinder bearing focuses on the construction of a pumping system above the electric motor. In this case, the kit of the compressor is assembled inversely on the shell. One of the disadvantages of this technique is that the coils of the electric motor are not immersed in the oil, this direct contact being the most efficient manner to cool them. If cooling is inefficient, the materials that isolate and conduct the motor have more degenerative effects.

In this regard, another technique that can be used for more efficient lubrication is the reduction of the pumping height, by increasing the amount of oil in the reservoir. However, this technique has a higher cost due to the greater amount of oil, and there is also the possibility of having the oil in contact with the rotor's lower surface, causing the whirling and formation of oil foam, limiting its capacity of lubricating and cooling the system.

Additionally, another technique used to ensure lubrication is to control the angular velocity of the vertical shaft. Thus, the technique comprises a minimum limit of rotational speed of the vertical shaft for oil pumping, but consequently limits the work ranges of these compressors. It is important to highlight that this problem becomes worse in variable capacity compressors (VCC), once they seek to operate at low rotations.

For this reason, the system that is most similar to this invention can be exemplified by Brazilian patent PI 9706307-0, which seeks to present a different construction of the hermetic compressor, in which the set of movable pieces in the motor is properly lubricated regardless of its position inside the structure, without the mentioned problems. In this regard, the hermetic compressor comprises a channel for oil conduction, with a lower end immersed in lubricating oil, whereas the upper part is associated with a radial duct. Therefore, in these compressors, the pumping efficiency is function of the relation between a smaller diameter, presented by the lower end of the oil pump immersed in the reservoir for lubricating oil, and a bigger diameter, represented by the inner diameter in the section of the revolving vertical shaft where the point of oil availability is found. The closer the values of the diameters; the lower the lubrication efficiency.

### Purposes and Brief Description of the Invention

To overcome the problems of the state of the art, the present invention refers to an oil pumping system for hermetic compressor wherein it is possible to ensure a suitable lubrication of all the compressor's mechanism, mainly for compressors of variable angular velocity which operate at low rotations, as well as elimination of geometrical restrictions to the formation of the oil parabolic profile.

Another purpose of the present invention is to supply a system where it is possible to limit the oil flow rate at high rotations and, thus, cause the reduction of the external circulation of lubricating oil in the cooling systems (lubricating oil pumped outside the compressor), reducing costs, maintenance and loss of efficiency in thermodynamic systems.

Such purposes are achieved by means of an oil pumping system for hermetic compressor, such hermetic compressor comprising at least a reservoir for lubricating oil, a revolving vertical shaft, which comprises an inner portion and an outer portion, an oil pump associated with the revolving vertical shaft, the pump comprising a suction hole in a lower end, whereas the oil pump is immersed in the reservoir for lubricating oil, the compressor further having an area that can be lubricated, the revolving vertical shaft further comprises a bent hole in its inner portion, and the bent hole is capable of conducting the lubricating oil to the area that can be lubricated and has an axial inclination in relation to the vertical center line of the revolving shaft.

Furthermore, the position of the oil pump in the shaft, the reduction of the oil pump's suction hole, and the definition of quotas and tolerances of position of the bent inner hole allows achieving the purposes abovementioned.

### BRIEF DESCRIPTION OF THE DRAWINGS

The present invention will be described in more details next, based on an example of implementation represented in the drawings. The figures show:

FIG. 1—is a section of part of a compressor built according to the prior arts;

FIG. 2—is a section of part of a compressor built according to the art that is most similar to the invention;

FIG. 3—is a section of the revolving vertical shaft of a compressor built according to the same art of FIG. 2;

FIG. 4—is a section of part of a compressor according to this invention;

FIG. 5—is a representation of the current state of the art; in detail the oil profile in the region of interference between the oil pump and the revolving vertical shaft;

FIG. 6—is a representation of the invention; in detail the oil profile in the region of interference between the oil pump and the revolving vertical shaft;

FIG. 7—is a section illustrating, in details, the region of association between the oil pump and the revolving vertical shaft.

### DETAILED DESCRIPTION OF THE FIGURES

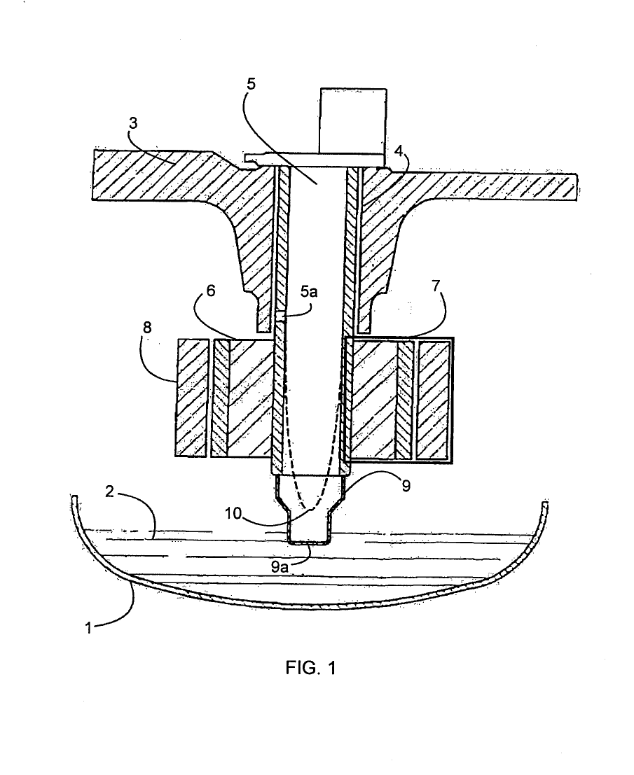

FIG. 1 illustrates a hermetic compressor of the state of the art, which comprises a hermetic structure 1 which has a reservoir for lubricating oil 2. The compressor further comprises a block 3, associated with a bearing 4 which provides mechanical support for a revolving vertical shaft 5 and a rotor 6 of an electric motor 7, responsible for the rotation of the system, fixed to the block 3, the electric motor 7 further comprising a stator 8.

The revolving vertical shaft 5 has, on its lower surface, an oil pump 9, with a lower end immersed in lubricating oil 2, which further comprises a suction hole 9a. During the rotation of the revolving vertical shaft 5 and the oil pump 9, the lubricating oil 2 forms a parabola and rises by centrifugation up to a distribution hole 5a on an intermediate part of the revolving vertical shaft 5, which distributes lubricating oil 2 to a lubricating area, which comprises parts that have related movements, away from the reservoir for lubricating oil 2.

Therefore, the pumping efficiency is function of the relation of a smaller diameter, defined by the suction hole 9a of the oil pump 9, and a bigger diameter, represented by the diameter of the section of the revolving vertical shaft 5 where the distribution hole 5a is located, and the closer these values are, the lower the lubricating efficiency is. This efficiency also depends on the distance between the level of the lubricating oil 2 and the position of the hole of oil availability 5a.

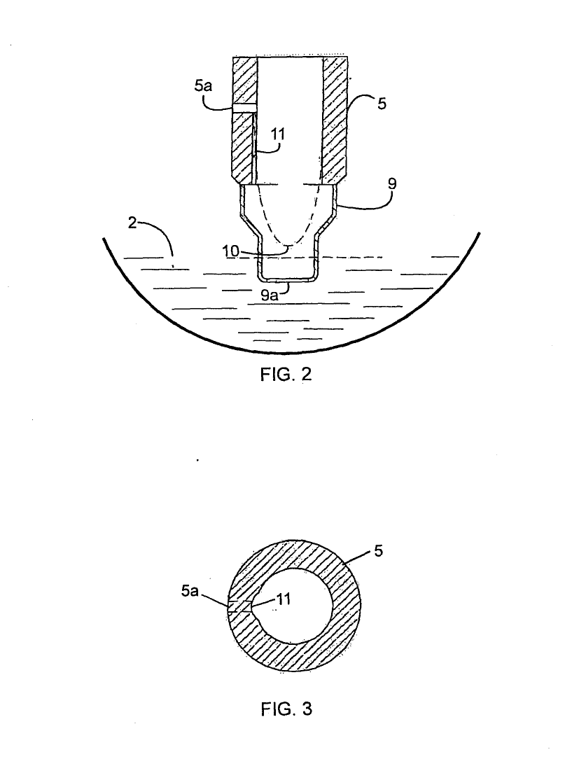

FIG. 2 represents a compressor that has more similarities to this invention, comprising an inner channel 11 machined on an inner surface of the revolving vertical shaft 5. Therefore, there is an increase in the inner diameter of the revolving vertical shaft 5 on the section of the distribution hole 5a. A representation of this increase is presented by FIG. 3, which demonstrates the increase of the diameter by means of the addition of the inner channel 11. Therefore, this construction comprises increased efficiency in the pumping of lubricating oil 2 represented by an increase of the parabola, as previously explained.

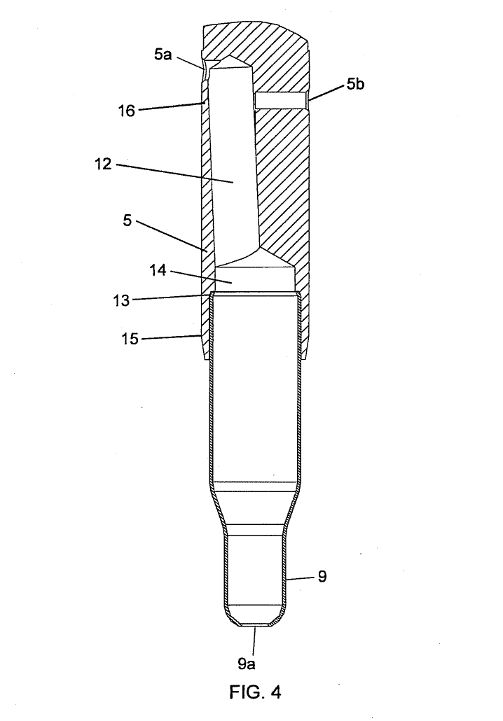

FIG. 4 illustrates a preferable characterization of the present invention, which has a better oil flow rate by means of specific changes. The revolving vertical shaft 5 of the figure comprises an inner portion 14 and an outer portion 15. It is important to note that the preferable direction of the revolving vertical shaft 5 is vertical in relation to the ground. One of these changes is the addition of a bent hole 12 in the inner portion 14 of the revolving vertical shaft 5, preferably within a range from 2.4° to 2.7° bent in relation to the center line of the revolving vertical shaft 5. This inclination results in the progressive increase of the radial distance between the external wall 16 of the bent hole 12 and the center line of the revolving vertical shaft 5 and, thus, there are bigger values of thickness of the lubricating oil profile 2.

Similarly, the definition of quotas and tolerances for the execution of this bent hole, and for the execution of a distribution hole 5a, results in the better distribution of lubricating oil 2. In a preferential embodiment of the invention, the revolving vertical shaft 5 also comprises a degasification hole 5b, preferably arranged below the distribution hole 5a, as presented by FIG. 4. This degasification hole 5b is preferably located on a specific position, defined by the axial clearance between the rotor 6 and the block 3.

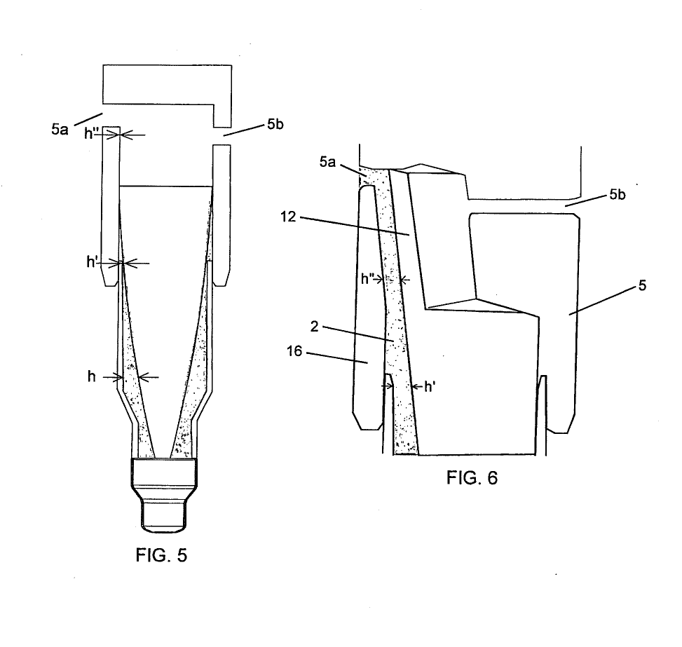

This change also seeks to decrease the restriction of the lubricating oil profile 2, once, in a different set of the invention with a concentric hole, the lubricating oil 2 is restricted in parts of the wall 16 of the revolving vertical shaft 5, as illustrated in FIG. 5 (please see h, h′ and h″), which represents, in detail, the lubricating oil profile 2 in the region of interference between the oil pump and the revolving vertical shaft, whereas the preferable configuration of the invention does not have this restriction due to the inclination of the bent hole 12, as illustrated by FIG. 6 (please see h′ and h″), which shows, in detail, the lubricating oil profile 2 in the region of interference between the oil pump and the revolving vertical shaft 5. Thus, it is also possible to reduce the thickness of the wall 16 of the revolving vertical shaft 5 progressively, resulting in a small thickness of wall 16 only in the region for delivering lubricating oil 2. At this point, the thickness of the wall 16 is generally between 0.89 mm and 1.44 mm (preferably to 1 mm, however variable depending on the material on which the shaft is manufactured, which, in this preferable embodiment, is molten iron), seeking to increase the thickness of lubricating oil 2 in this region.

Therefore, the tolerances of the inclination of the bent hole 12, of the position of the bent hole 12 in relation to the axial center of the revolving vertical shaft 5 and the diameter of the bent hole 12 are determined by the thickness of the wall 16, which needs a minimum value as already determined for maintaining the integrity of the revolving vertical shaft 5. Considering the lower portion of the bent hole 12, according to the present invention, its center in relation to the axial center of the revolving vertical shaft 5 can be substantially displaced, for instance, from 2.0 to 2.2 mm.

It is important to note that the construction of the bent hole allows more hardiness to the revolving vertical shaft 5, once, in the prior arts, the thickness of the wall 16 was always constant and with a small width, enabling deformations in the revolving vertical shaft 5 which may result in unbalances, rupture of the revolving vertical shaft 5 or even failures in movement. In the construction of this invention, this shaft has more thickness on the wall 16, and the reduction in the thickness of the wall 16 is progressive; therefore, a small width occurs only in the proximity of the distribution hole 5a.

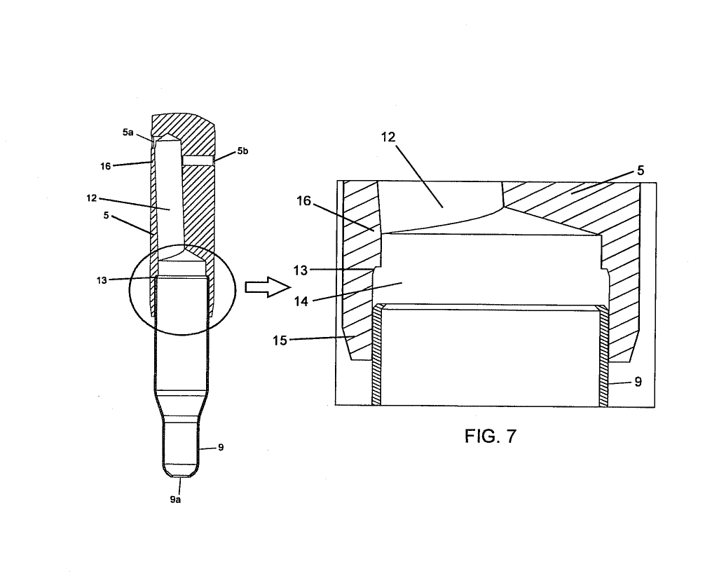

Moreover, another modification is the change in the position for fixing the oil pump 9 defined by means of a limiting recess 13. This change allows restrictions in view of the inner wall of the oil pump, as illustrated in FIG. 5 (h′), to be reduced, whereas the preferential embodiment of the invention is presented by FIG. 6 (h′). FIG. 7 illustrates an oil pump 9 before the final fitting, where the limiting recess 13, which acts as an insertion guide, is located on an inner portion of the revolving vertical shaft 5, preferably at a height of 11.5 mm from its lower end, once it is necessary to ensure a minimum length of the parabola for conducting the lubricating oil 2 to the distribution hole 5a, also ensuring that the pump will not be released. Similarly, it is important to highlight that the limiting recess can be created on the outer portion of the revolving vertical shaft 5 if a different construction of the pump and shaft are presented. This change is due to the fact that the thickness of the pumped lubricating oil 2 (distance between the wall of the inner hole and the parabolic profile) decreases according to the raise in the distance in relation to the level of oil in the reservoir and, therefore, the inner wall of the oil suction pump can generate a restriction to the rising profile if it is fixed to the shaft by means of a great length of interference.

Additionally, a third change is the reduction of the diameter of the suction hole 9a of the oil pump 9, preferably to 3 mm, causing the consequent raise in the oil flow rate at low rotations, thus solving one of the problems mentioned in the prior arts, in which often the lubricating oil 2 does not have enough power to reach the distribution hole 5a at low rotations. On the other hand, this embodiment limits the flow rate at high rotations and, therefore, causes the reduction of the external circulation of lubricating oil 2 in the cooling systems (lubricating oil 2 pumped outside the compressor), reducing costs and maintenance, as shown by the table below.

| | 800 rpm | 900 rpm | 000 rmp | 400 rpm | 000 rpm | 600 rpm | 500 rpm |
|---|---|---|---|---|---|---|---|
| 0 mm | 100 | 19.9598 | 3.96679 | 4.01522 | 1.38777 | 19.1043 | 39.6127 |
| 5 mm | 100 | 11.4263 | 6.15982 | .965448 | 9.29844 | 1.13462 | 36.3346 |
| 0 mm | 10.4927 | 3.46478 | .101657 | .769834 | 0.71828 | 3.27824 | 11.1336 |

The values on the table show the percentage of flow rate variation in millimeters per second of the oil pump 9 with diameter of the suction hole 9a at 4.36 mm, taking as reference the oil pump 9 with diameter of the suction hole 9a at 3 mm at different depths of immersion in lubricating oil and different rotational speeds. These values vary according to the formula

$$( \frac{{□}_{4 , 3} - {□}_{3}}{{□}_{3}} ) * 100$$

and, therefore, negative variations demonstrate that the flow rate values with suction hole of 3 mm are higher in relation to the pump of 4.36 mm whereas flow rates of −100 demonstrate embodiments where the lubricating oil 2 was not delivered to the distribution hole 5a when the suction hole 9a of the pump had the size of 4.36 mm. The lines (10, 15, 20) are related to deepness, in mm, of immersion of the oil pump 9 in the lubricating oil 2, whereas the columns (1800 to 4500) are related to the rotational speed of the revolving vertical shaft 5, in rpm.

It is worth noting that the changes result in a reduction of the restriction to the parabolic profile of the lubricating oil 2 pumped from the level of lubricating oil 2 up to the section where the bent distribution hole 5b is located, which hole distributes the lubricating oil 2 to the movable parts away from the reservoir of lubricating oil 2.

After describing an example of a preferred embodiment, it shall be understood that the scope of the present invention encompasses other possible variations, being limited only by the contents of the attached claims, where the possible equivalents are included.

1.-30. (canceled)

30. An oil pumping system for a hermetic compressor, said hermetic compressor comprising:
a reservoir for lubricating oil (2);
a revolving vertical shaft (5), which comprises an inner portion (14) and an outer portion (15);
an oil pump (9) associated with the revolving vertical shaft (5), the pump comprising a suction hole (9a) at a lower end, wherein the oil pump (9) is immersed in the reservoir for lubricating oil (2);
the compressor further comprising an area that can be lubricated, wherein the revolving vertical shaft (5) comprises a bent hole (12) on its inner portion (14), the bent hole (12) being capable of distributing lubricating oil (2) to the area that can be lubricated, the bent hole (12) comprising an angle within a range from 2.4° to 2.7° of inclination in relation to the center line of the revolving vertical shaft (5).

31. The oil pumping system for a hermetic compressor according to claim 30, wherein the bent hole (12) comprises an axial center substantially displaced in relation to the center line of the revolving vertical shaft (5).

32. The oil pumping system for a hermetic compressor according to claim 30, wherein the revolving vertical shaft (5) comprises a limiting recess (13) on its inner portion (14) for association with the oil pump (9).

33. The oil pumping system for a hermetic compressor according to claim 32, wherein the limiting recess (13) is located approximately 11.5 mm above the lower end of the revolving vertical shaft (5).

34. The oil pumping system for a hermetic compressor according to claim 30, wherein the suction hole (9a) of the oil pump (9) is approximately 3 mm.

35. The oil pumping system for a hermetic compressors according to claim 30, wherein the oil pump (9) is capable of centrifugally propelling lubricating oil (2) by means of the bent hole (12) up to the area that can be lubricated.

36. The oil pumping system for a hermetic compressors according to claim 30, wherein the revolving vertical shaft (5) further comprises a distribution hole (5a) for distributing lubricating oil (2) to the area that can be lubricated on an upper end of the bent suction tube (12).

37. The oil pumping system for a hermetic compressor according to claim 36, wherein the distribution hole (5a) forms a channel for oil distribution from the inner portion (14) to the outer portion (15) of the revolving vertical shaft (5).

38. The oil pumping system for a hermetic compressor according to claim 30, wherein the revolving vertical shaft (5) further comprises a degasification hole (5b).

39. The oil pumping system for a hermetic compressor according to claim 38, wherein the degasification hole (5b) is located on the upper end of the bent hole (12), under the distribution hole (5a) in relation to the bent hole (12).

40. The oil pumping system for a hermetic compressor according to claim 39, wherein the degasification hole (5b) is orthogonally opposite to the distribution hole (5a) in relation to the axial shaft of the revolving vertical shaft (5).

41. The oil pumping system for a hermetic compressor according to claim 30, wherein the revolving vertical shaft (5) is solid in its inner portion (14), except for the areas of the bent hole (12), the area of association with the oil pump (9) and the area of the distribution hole (5a).

42. The oil pumping system for a hermetic compressor according to claim 38, wherein the revolving vertical shaft (5) is solid in its inner portion (14), except for the areas of the bent hole (12), the area of association with the oil pump (9), the area of the distribution hole (5a) and the area of the degasification hole (5b).

43. A revolving vertical shaft (5) for an oil pumping system for a hermetic compressor, the shaft comprising a bent hole (12) in an inner portion (14), the bent hole (12) comprising an inclination in relation to a center line of the revolving vertical shaft (5), the bent hole (12) comprising an angle within a range from 2.4° to 2.7° of inclination in relation to a center line of the revolving vertical shaft (5).

44. The revolving vertical shaft according to claim 43, wherein the bent hole (12) comprises an axial center substantially displaced from the axial center line of the revolving vertical shaft (5).

45. The revolving vertical shaft according to claim 43, wherein the revolving vertical shaft (5) further comprises a limiting recess (13) in its inner portion (14) for association with an associated oil pump (9).

46. The revolving vertical shaft according to claim 45, wherein the limiting recess (13) is located approximately 11.5 mm above a lower end of the revolving vertical shaft (5).

47. The revolving vertical shaft according to claim 43, wherein the revolving vertical shaft (5) further comprises a distribution hole (5a) for distributing lubricating oil (2) to the area that can be lubricated adjacent an upper end of the bent hole (12).

48. The revolving vertical shaft according to claim 47, wherein the distribution hole (5a) forms a channel for distributing oil from the inner portion (14) up to the outer portion (15) of the revolving vertical shaft (5).

49. The revolving vertical shaft according to claim 47, wherein the revolving vertical shaft (5) further comprises a degasification hole (5b).

50. The revolving vertical shaft according to claim 49, wherein the degasification hole (5b) is located on an upper end of the bent hole (12), below the distribution hole (5a).

51. The revolving vertical shaft according to claim 50, wherein the degasification hole (5b) is orthogonally located opposite to the distribution hole (5a) in relation to the center line of the revolving vertical shaft (5).

52. The revolving vertical shaft according to claim 47, wherein the revolving vertical shaft (5) is solid in its inner portion (14), except for the areas of the bent hole (12), the area of association with the oil pump (9) and the area of the distribution hole (5a).

53. The revolving vertical shaft according to claim 49, wherein the revolving vertical shaft (5) is solid in its inner portion (14), except for the areas of the bent hole (12), the area of association with the oil pump (9), the area of the distribution hole (5a) and the area of the degasification hole (5b).

54. An oil pumping system for hermetic compressors comprising:
a reservoir for lubricating oil (2);
a revolving vertical shaft (5), which comprises an inner portion (14) and an outer portion (15);
an oil pump (9) associated with the revolving vertical shaft (5), the pump comprising a suction hole (9a), whereas the oil pump (9) is immersed in the reservoir for lubricating oil (2);
wherein the revolving vertical shaft (5) comprises a bent hole (12) on its inner portion (14), the bent hole (12) being capable of distributing lubricating oil (2) to an area of an associated hermetic compressor that can be lubricated, the bent hole (12) comprising an angle within a range from 2.4° to 2.7° of inclination in relation to a center line of the revolving vertical shaft (5).

55. The oil pumping system according to claim 54, wherein said oil pumping system is connected to a hermetic compressor comprising said area that can be lubricated, and wherein the bent hole (12) distributes lubricating oil to said area that can be lubricated.
